(19) United States
(12) Patent Application Publication
(10) Pub. No.: US 2010/0327602 A1
(43) Pub. Date: Dec. 30, 2010

(54) Road farm unit

(76) Inventor: William Jordan, New Hyde Park, NY (US)

Correspondence Address: WILLIAM JORDAN, 4 Stephen Ave., New Hyde Park, NY, 11040, US

(21) Appl. No.: 12/455,068

(22) Filed: Jun. 29, 2009

(51) Int. Cl. F03G 7/00

(52) U.S. Cl. 290/1 R

(57) ABSTRACT

Taking advantage of a provisional patent filed Jan. 21, 2009 confirmation number 8217. 1 hereby claim to be the original inventor of the road farm unit. The units are set In each lane of a road or rail road track. Vehicles or trains passing over said units would spin a wheel connected to a generator thereby creating electric power. Advantages over wind farm units which need wind over 15 mph to produce electric power are much more costly and are usually many miles from a power grid and also kill birds.

### BRIEF SUMMARY OF THE INVENTION

The Road Farm Units would produce electricity from moving vehicles or trains as they pass over said units. The units could add to or replace costly Wind Farms and Solar Panels and create a MULTITUDE of jobs, cut down on greenhouse gases and slow down or do away with our dependence of foreign oil. There are 2 types of units one being a Rubber Wheel the other a Turbine Wind Wheel. Both the wheels are encased in the same type of cement box but have different tops. The wheels are connected to a generator or alternator to produce electricity for distribution. The power produced could power building adjacent to a road, traffic and street lights, even stations along a road to charge your electric/hybrid vehicle. Excess power would be sent back to the electric company's power grid.

### DETAILED DESCRIPTION OF THE INVENTION

There are two types of Road Farm Units, a rubber wheel type #21 and a wind turbine type #22.

Both units are to be used on roads or highways #19 or railroad tracks #20. The purpose is to produce electricity from a spinning wheel.

The first type is solid rubber wheel #1 with tire type treads #24 in it with a center shaft #3 that goes through a ball bearing hub #2. The hub #2 is supported at each end by a bracket #4. The wheel #1 is set in a pre-cast reinforced cement housing #6 which has an adjusting bolt #5, and the wheel is adjusted so it is slightly above the road #7. There are curve tops #10 with a slight clearance between them and the wheel, and are hinged #11 so wheel #1 and bracket #4 assembly can be removed for replacement or repairs. The units are placed along a road #7 in a irregular pattern and are made just wide enough so one side of a vehicle would only have to pass over to spin wheel #1. The whole unit #21 could be about 3 or 4 feet wide. A dry well #9 could be incorporated for use in a high rainfall area. The unit #21 is fastened to the road by security fasteners #8 through the top flange #12. In a railroad #20 application the units would be placed between the track and the railroad ties#20. A small flexible flapper could be installed under the train to spin the wheel #1. The unit #21 would have to be placed slightly above the railroad ties #20.

The second type of unit #22 is a Wind Turbine Wheel #15 which would be used instead a rubber wheel #1. A different type of top #18 is used to direct the wind from passing vehicles as show by arrow #17, to spin the wheel #15. The turbine wheel would be made of a light weight aluminum or plastic. This type of unit #22 would be placed in a center lane #19 so the center part of a vehicle would pass over it. In a railroad #20 installation, there would be no need for a flapper under the train.

### BRIEF DESCRIPTION OF THE SEVERAL VIEWS OF THE DRAWINGS

FIG. 1: Side End View—Shows a rubber wheel #1 slightly above the road #7 supported by a bracket #4 encased in a cement box #6 which has an adjusting bolt #5 and a curved top #10 that is hinged for installation and maintenance purposes. In addition an optional dry well #9 for heavy rainfall areas.

FIG. 2: Open Side View—Shows rubber wheel #1 center shaft #3 with a ball bearing hub #2 on each end. A generator or alternator #13 and conduit #14. There are security fasteners #8 for the top flange #12 and curved top #10 along with tire treads #24 on the wheel.

FIG. 3: Top View of Unit—#21 encased in a road #7

FIG. 4: End View—Is the second type of unit #22. The only difference being a wind turbine #15 and a Wind Scoop Top #18 instead of a rubber wheel #1 type.

FIG. 5: Side View—This is a Wind Turbine type #22.

FIG. 6: Top View of Wind Turbine Type—#22

FIG. 7: Top View of a typical two lane road #9 with units #21 in different lanes as not to tie up traffic for installation or repairs.

FIG. 8: Top View of Railroad Track—#20 with units #21 placed between the tracks #20.

FIG. 9: Top View of Typical Two Lane Road—#19 with units #22 in the center of different lanes.

FIG. 10: Top View of Railroad Track—#20 with units #22 between the tracks #20

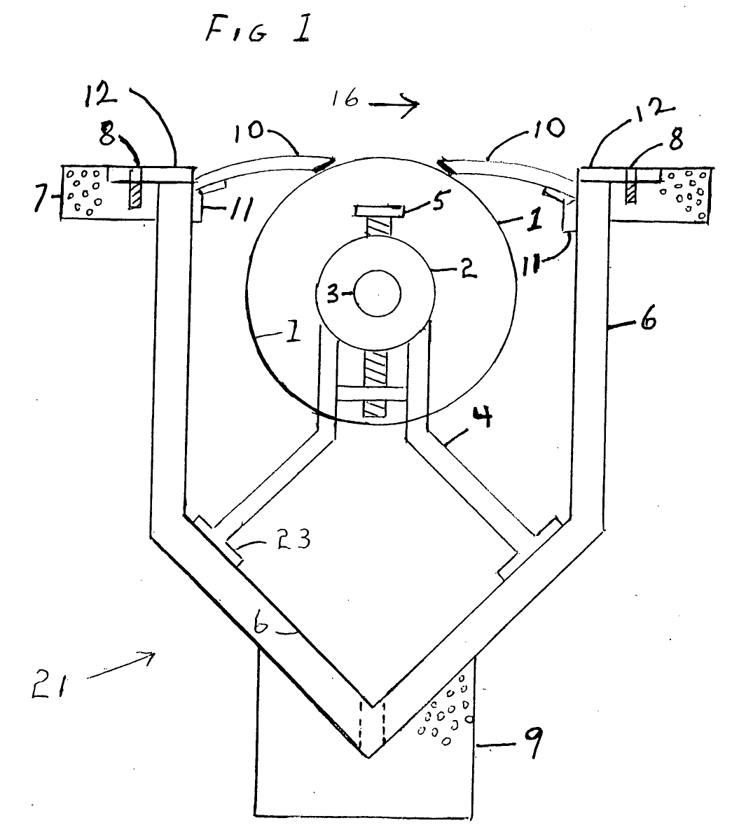

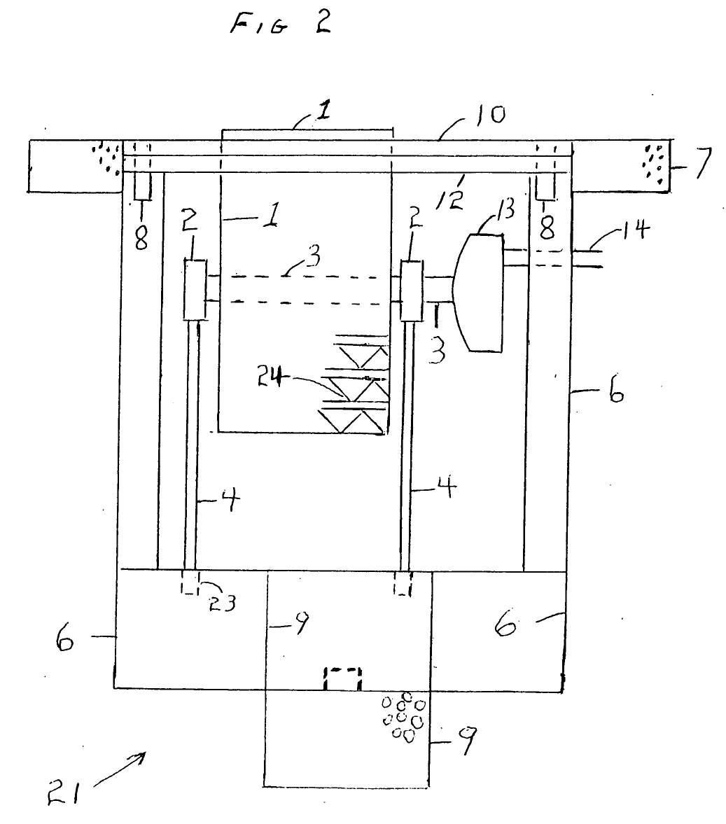

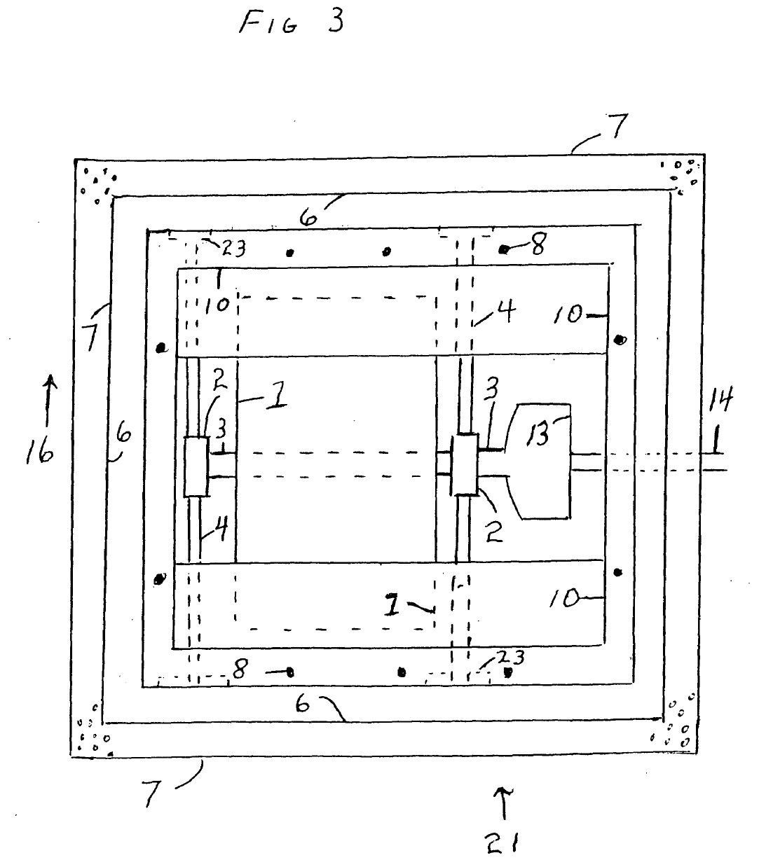

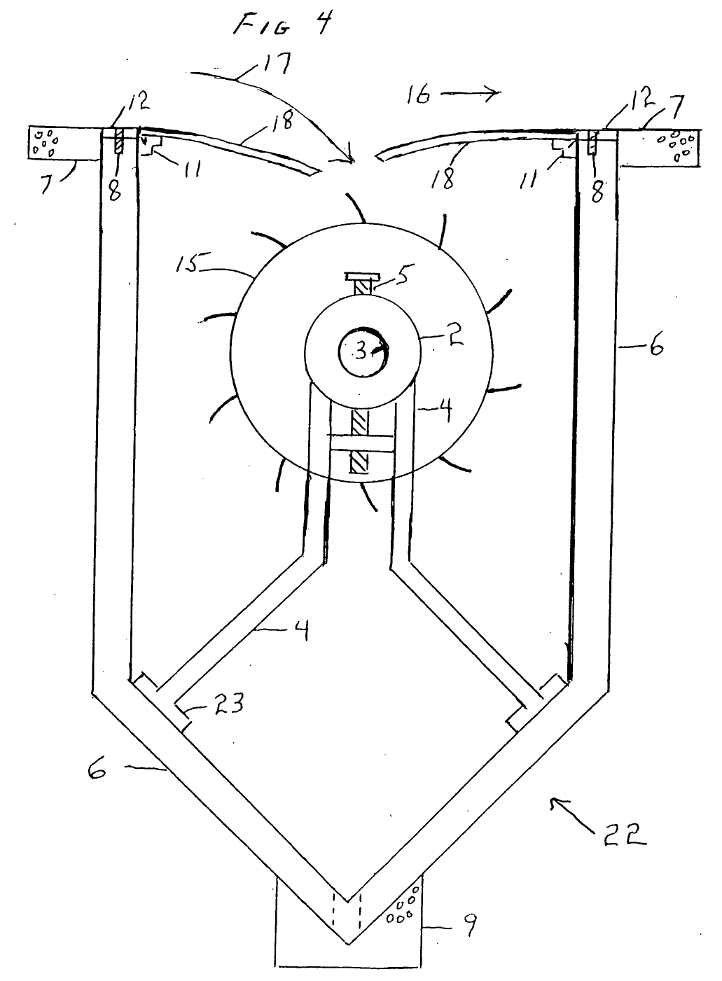

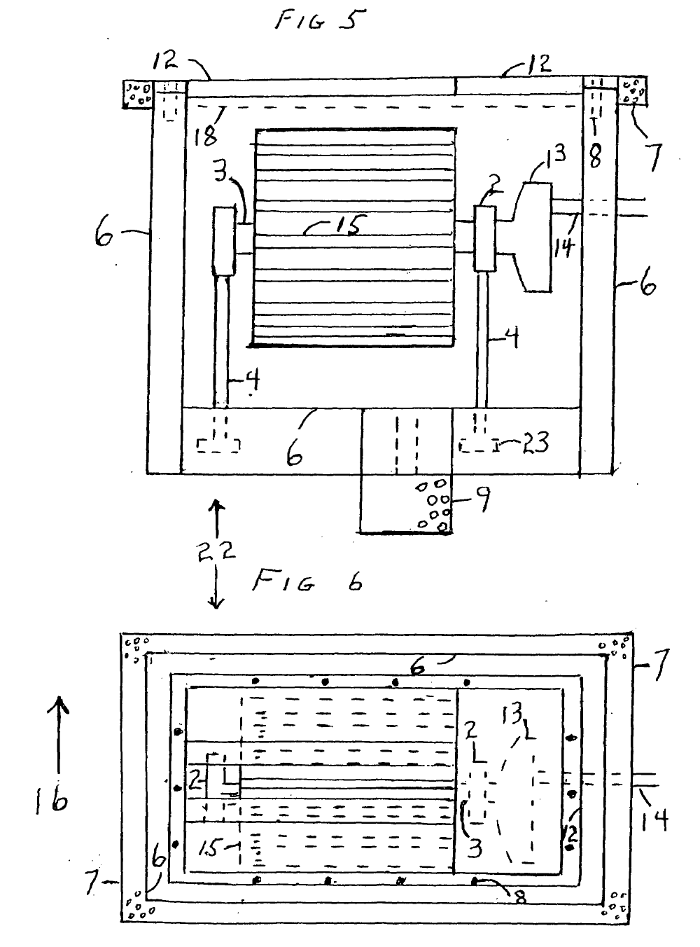

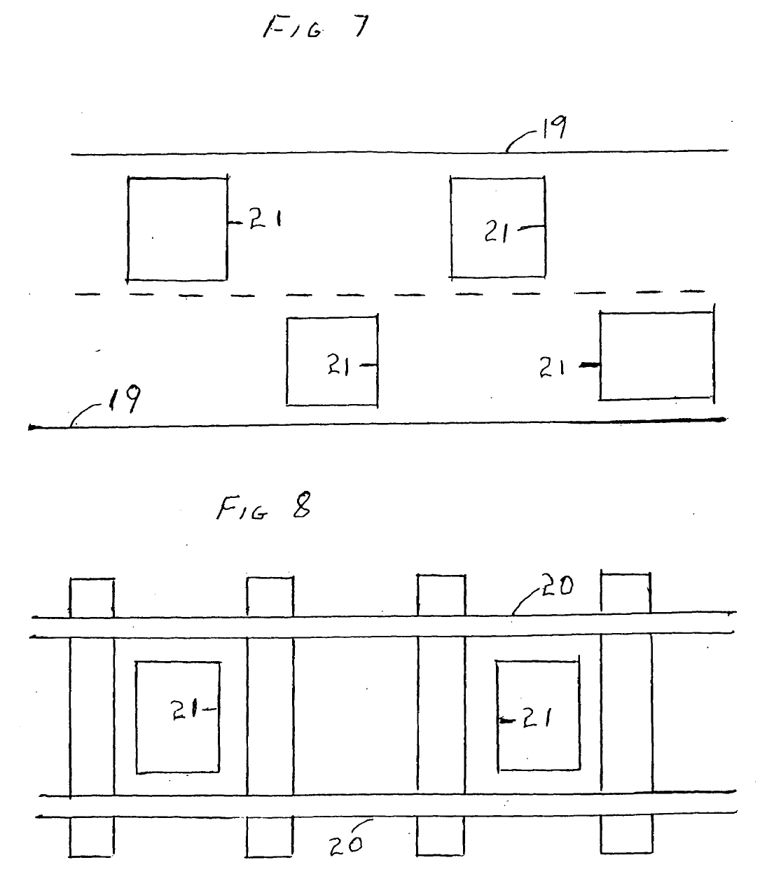

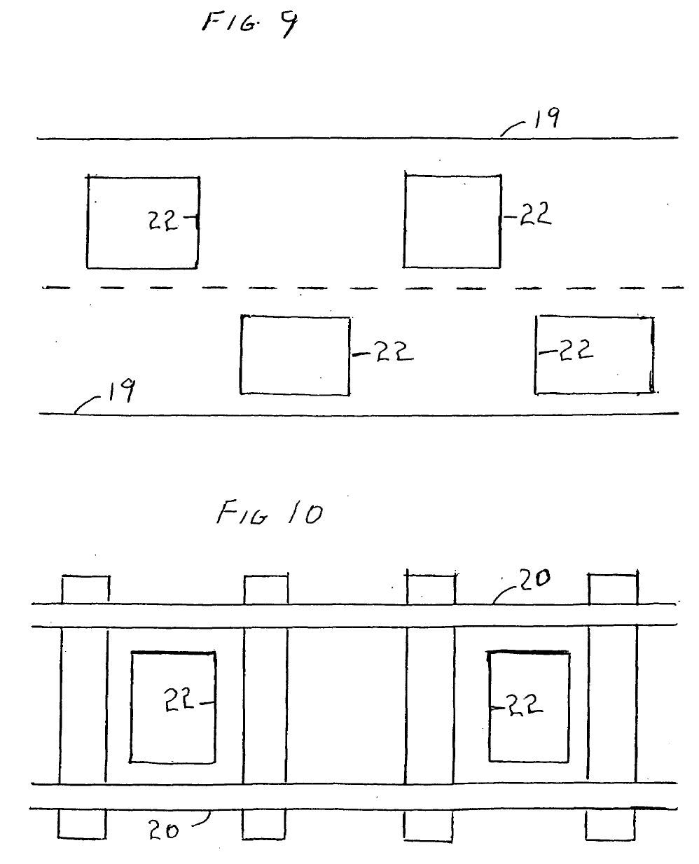

### COMPONENTS FOR DETAILED DESCRIPTION

1. Rubber Wheel

2. Ball Bearing hub

3. Wheel Shaft

4. Hub and Wheel Bracket

5. Adjusting Bolt

6. Cement Housing

7. Road

8. Flange Security Fasteners

9. Dry Well

10. Curved Top For Rubber Wheel

11. Hinge

12. Flange

13. Generator or Alternator

14. Conduit

15. Turbine Wind Wheel

16. Arrow For Traffic Direction

17. Arrow For Wind Direction

18. Wind Scoop Top For Wind Wheel

19. Two Lane Road or Multi Lane Highway

20. Railroad Track

21. Complete Rubber Wheel Unit

22. Complete Wind Wheel Unit

23. Bracket Feet

24. Rubber Wheel Tred

1. (canceled)

2. (canceled)

3. (canceled)

4. (canceled)

5. (canceled)

6. (canceled)

7. Road Farm Units are to be a new way of producing electricity without fossil fuel, hydro, solar or wind. Units would be set In a road or between railroad tracks. In roads, they would be set In each single lane. The distance between them would be by the amount of traffic expected. The units would be comprised of a wheel connected to a generator. Both being in cased In a performed reinforced cement housing with a V shaped bottom and a dry well under If needed. In dry climates the housing could be smaller, without a V bottom or dry well. Units would have a small opening and rise, as not to cause a bump In the road. Vehicles pass over said units spin the wheels and create electricity.

8. There are two types of wheels, one is made of solid rubber approximately one foot In diameter and two feet long. The other type would be a plastic or aluminum turbine wheel of approximately the same size. The rubber type wheel is spun by direct contact by one side of an automobile's front and rear tires, or by a flexible flapper under a train. The turbine type, is spun by wind caused by vehicles that pass over the center of each lane In a road or In the center of any road or railroad track.
